(19) United States
(12) Patent Application Publication
(10) Pub. No.: US 2024/0177086 A1
(43) Pub. Date: May 30, 2024

(54) WORK ASSISTANCE APPARATUS, WORK ASSISTANCE SYSTEM, AND WORK ASSISTANCE METHOD

(71) Applicant: Mitsubishi Electric Corporation, Tokyo (JP)

(72) Inventors: Atsuko AOKI, Tokyo (JP); Koichi NAKAGAWA, Tokyo (JP)

(73) Assignee: Mitsubishi Electric Corporation, Tokyo (JP)

(21) Appl. No.: 18/283,215

(22) PCT Filed: Mar. 30, 2021
(86) PCT No.: PCT/JP2021/013510

§ 371 Date: Sep. 21, 2023

(51) Int. Cl. G06Q 10/0631; G06Q 10/0633

(52) U.S. Cl. CPC G06Q 10/06312; G06Q 10/0633

(57) ABSTRACT

Production efficiency in a production line is improved. A work assistance apparatus includes a profile information evaluation unit that evaluates degree of change in profile information based on worker information and production facility information, a correction estimation unit that estimates a correction method of profile information and a correction effect caused by the correction method based on evaluation in the profile information evaluation unit, and an instruction determination unit that determines a correction instruction for at least one of a worker and a production facility to perform correction based on a corresponding correction method based on a correction effect.

### TECHNICAL FIELD

A technique disclosed in the present description relates to a work assistance technique.

### BACKGROUND ART

In a production line of a factory or the like, decrease in the number of workers who perform work in the production line, aging of the workers, or the like is a problem. For this reason, in a production line of a factory or the like, many automation techniques such as an industrial robot or a process automation system have been put into practical use in order to reduce burden on a worker and improve production efficiency.

However, work content performed by a worker in a production line is often set based on a skill level of the worker or a performance index at the time of manufacturing of a production facility in a production line, and influence of a daily condition represented by a physical condition of a worker is often not considered. With respect to this, a technique of presenting work content based on a physical condition of a worker in a production line of a factory or the like is disclosed (See, for example, Patent Document 1).

### PRIOR ART DOCUMENT

### Patent Document

Patent Document 1: Japanese Patent Application Laid-Open No. 2020-017058

### SUMMARY

### Problem to be Solved by the Invention

In a case where work content is presented based on a physical condition of a worker as described above, work content in which a worker is engaged can be appropriately changed according to a daily condition of the worker. However, since performance of a production line may decrease due to a factor other than a daily condition of a worker, there has been a case where production efficiency in a production line is lowered.

A technique disclosed in the present description has been made in view of the problem as described above, and is a technique for improving production efficiency in a production line.

### Means to Solve the Problem

A work assistance apparatus according to a first aspect of a technique disclosed in the description of the present application includes a profile information evaluation unit for generating at least one piece of profile information that is information including work capacity of a worker who performs work in cooperation with a production facility and work capacity of the production facility based on at least one piece of worker information that is information on the worker and at least one piece of production facility information that is information on the production facility, and further evaluating degree of change in the profile information with reference to reference profile information that is information including work capacity that is a reference of the worker and work capacity that is a reference of the production facility, a correction estimation unit for estimating a correction method of the profile information and a correction effect caused by the correction method based on evaluation by the profile information evaluation unit, and an instruction determination unit for determining a correction instruction for at least one of the worker and the production facility for performing correction based on a corresponding one of the correction method based on the correction effect.

### Effects of the Invention

According to at least the first aspect of the technique disclosed in the description of the present description, production efficiency in a production line can be improved.

Further, an object, a feature, an aspect, and an advantage relating to the technique disclosed in the description of the present description will be further clarified by detailed description below and the accompanying drawings.

### BRIEF DESCRIPTION OF DRAWINGS

FIG. 1 is a diagram conceptually illustrating an example of a configuration of a work assistance system according to an embodiment.

FIG. 2 is a diagram schematically illustrating an example of a configuration of a production line in which work is assisted by the work assistance system according to the embodiment.

FIG. 3 is a flowchart illustrating an example of processing performed by the work assistance system according to the embodiment.

FIG. 4 is a diagram illustrating an example of worker information and a time stamp stored in the work assistance system according to the embodiment.

FIG. 5 is a diagram illustrating an example of production facility information and a time stamp stored in the work assistance system according to the embodiment.

FIG. 6 is a diagram conceptually illustrating an example of a configuration of the work assistance system according to the embodiment.

FIG. 7 is a flowchart illustrating an example of processing performed by the work assistance system according to the embodiment.

FIG. 8 is a diagram conceptually illustrating an example of a configuration of the work assistance system according to the embodiment.

FIG. 9 is a flowchart illustrating an example of processing performed by a profile information learning unit in the work assistance system.

FIG. 10 is a diagram conceptually illustrating an example of a configuration of the work assistance system according to the embodiment.

FIG. 11 is a flowchart illustrating an example of processing performed by a profile correlation estimation unit in the work assistance system.

FIG. 12 is a diagram illustrating an example of a correlation coefficient for a picking robot.

FIG. 13 is a diagram illustrating an example of a correlation coefficient in units of category data for an “operating state” of the picking robot.

FIG. 14 is a diagram illustrating an example of clustering of an evaluation result of profile information of a category name “gripping failure” in an “operating state” of the picking robot.

FIG. 15 is a diagram schematically illustrating a hardware configuration in a case where the work assistance system exemplified in FIG. 1, FIG. 6, FIG. 8, or FIG. 10 is actually operated.

FIG. 16 is a diagram schematically illustrating a hardware configuration in a case where the work assistance system exemplified in FIG. 1, FIG. 6, FIG. 8, or FIG. 10 is actually operated.

FIG. 17 is a diagram conceptually illustrating an example of a configuration (functional unit) of a work assistance apparatus according to the present embodiment.

### DESCRIPTION OF EMBODIMENTS

Hereinafter, a preferred embodiment will be described with reference to the attached drawings. In an embodiment below, a detailed feature and the like are also shown for explanation of a technique, but they are merely examples, and not all of them are necessarily essential features for enabling the embodiment to be carried out.

Note that the drawings are shown schematically, and for convenience of explanation, the configuration is omitted or the configuration is simplified on the drawings as appropriate. Further, an interrelationship between sizes and positions of configurations and the like shown in different drawings is not always accurately described and may be changed as appropriate. Further, hatching may be applied to a drawing such as a plan view that is not a cross-sectional view in order to facilitate understanding of content of an embodiment.

Further, in description shown below, similar constituents are illustrated with the same reference numerals. This similarly applies to their names and functions. Therefore, there is a case where detailed description of them is omitted to avoid duplication.

Further, in description described in the description of the present application, in a case where description of “comprising”, “including”, or “having” a certain constituent or the like is shown, such an expression is not an exclusive expression for excluding the presence of other constituents unless otherwise specified.

Further, in description described in the description of the present application, even if ordinal numbers such as “first” or “second” are used, these terms are used for convenience to facilitate understanding of content of the embodiment, and the content of the embodiment is not limited to order or the like that can be caused by these ordinal numbers.

### <Regarding Conceptual Configuration of Work Assistance Apparatus>

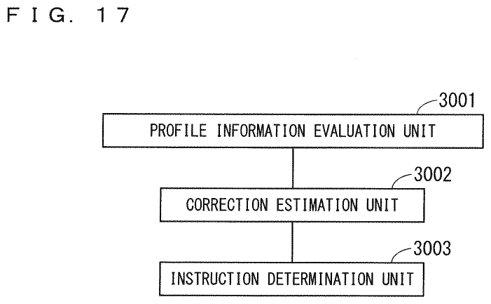

FIG. 17 is a diagram conceptually illustrating an example of a configuration (functional unit) of a work assistance apparatus according to the present embodiment.

As exemplified in FIG. 17, the work assistance apparatus includes a profile information evaluation unit 3001, a correction estimation unit 3002, and an instruction determination unit 3003.

The profile information evaluation unit 3001 generates at least one piece of profile information that is information including work capacity of a worker and work capacity of a production facility on the basis of at least one piece of worker information that is information on a worker who performs work in cooperation with a production facility and at least one piece of production facility information that is information on a production facility, and further evaluates degree of change in the profile information with reference to reference profile information that is information including work capacity that is a reference of a worker and work capacity that is a reference of a production facility.

The correction estimation unit 3002 estimates a correction method of profile information and a correction effect caused by the correction method on the basis of evaluation by the profile information evaluation unit.

On the basis of a correction effect, the instruction determination unit 3003 determines a correction instruction for at least one of a worker and a production facility for performing correction based on a corresponding correction method.

Each configuration illustrated using the drawings and the like in an embodiment below more specifically illustrates an example of the configuration illustrated in FIG. 17.

### First Embodiment

Hereinafter, a work assistance apparatus, a work assistance system, and a work assistance method according to the present embodiment will be described.

### <Regarding Configuration of Work Assistance Apparatus>

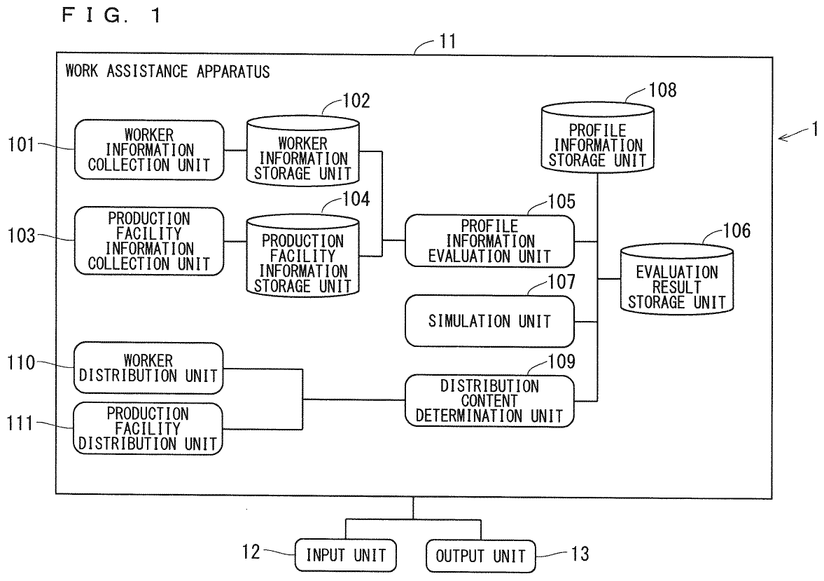

FIG. 1 is a diagram conceptually illustrating an example of a configuration of a work assistance system according to the present embodiment. As illustrated in FIG. 1 as an example, the work assistance system 1 includes a work assistance apparatus 11, an input unit 12, and an output unit 13. The work assistance system 1 according to the present embodiment is, for example, a system introduced into a production line of a factory.

The work assistance apparatus 11 estimates degree of influence on achievement of a production plan in a case where at least one of worker information and production facility information is changed on the basis of evaluation of profile information from worker information which is information on a worker who performs work in cooperation with a production facility in a production line and production facility information which is information on a production facility in a production line. Then, the work assistance apparatus 11 determines distribution content for correcting profile information on at least one of a worker and a production facility.

The profile information is information including attribute information that is information specific to a production facility or information specific to a worker, and performance index information that is information on work capacity exhibited by a production facility or a worker at a site where the work assistance system 1, such as a production line of a factory, is introduced. That is, the profile information is information indicating overall work capacity of a worker and a production facility.

For an example of a case where a production facility is a robot, profile information corresponding to the production facility will be described. Attribute information of the profile information can include information related to operation of a robot, such as “installation line name”, “administrator”, “application”, or “failure history”, in addition to a catalog specification value, such as “model name”, “manufacturing number”, “manufacturer name”, “maximum movable range”, or “maximum operation speed”. Further, performance index information of the profile information can include information calculated from actual operation data such as “work speed” or “work failure occurrence rate” calculated for each work object or work condition.

Next, profile information corresponding to a worker will be described. Attribute information of the profile information can include, in addition to personnel information such as “name”, “age”, “department to which the worker belongs”, “position”, “years of experience”, or “work restriction content”, information related to work content in which the worker is engaged, such as “possessing qualification” or “work experience history”. Further, performance index information of the profile information can include information calculated from actual operation data such as “work speed” or “work failure occurrence rate” calculated for each piece of work content or each work condition, as in the case of a production facility.

Note that the work assistance apparatus 11 may be configured by a single apparatus or may be configured by a plurality of combined apparatuses.

The input unit 12 and the output unit 13 are communicably connected to the work assistance apparatus 11, and each serves as a user interface of the work assistance apparatus 11. The input unit 12 inputs information to the work assistance apparatus 11. The output unit 13 outputs information from the work assistance apparatus 11.

The work assistance apparatus 11 includes a worker information collection unit 101, a worker information storage unit 102, a production facility information collection unit 103, a production facility information storage unit 104, a profile information evaluation unit 105, an evaluation result storage unit 106, a simulation unit 107, a profile information storage unit 108, a distribution content determination unit 109, a worker distribution unit 110, and a production facility distribution unit 111.

These elements may be configured by causing a computer to execute a program, or may be configured by hardware that does not execute a program.

The worker information collection unit 101 sequentially collects new worker information in real time. The collected worker information includes at least an individual identifier (ID) of a worker and information on a work situation of the worker. The individual identifier of a worker is an identifier for identifying the worker, and is, for example, a number assigned to the worker, a name of the worker, or the like. The collected worker information may include continuous work time of a worker, environmental data of a place where the worker is located, speech content of the worker, or the like. The environmental data is, for example, room temperature, humidity, illuminance, noise amount, or the like. Further, the collected worker information may include a length of actual required time of target work with respect to standard required time of the target work.

The information on a work situation of a worker is information indicating a progress situation of work that the worker is engaged in. The collected work situation is, for example, transition data such as the number of stocked work objects or the number of work objects for which work is completed. The work situation may be collected as a work start time, a work end time, an inspection result, or the like is recorded by a production management system or the like for each work object of the worker, or a progress situation of work of the worker may be collected by analyzing an image captured by a camera or the like.

The worker information storage unit 102 stores worker information. A new piece of the worker information collected by the worker information collection unit 101 is included in worker information stored in the worker information storage unit 102. The worker information stored in the worker information storage unit 102 may include worker information other than worker information collected by the worker information collection unit 101. For example, the worker information stored in the worker information storage unit 102 may include work management data as worker information other than worker information collected by the worker information collection unit 101. The work management data includes gender, age, a physical characteristic, presence or absence of chronic illness, content of chronic illness, presence or absence of work restriction, content of work restriction, years of experience, whether a worker is good and bad at each piece of work, possessing qualification, working hours, extra working hours, leave acquisition record, and the like. The physical characteristic among the above is, for example, height or weight.

The production facility information collection unit 103 sequentially collects new production facility information in real time. The collected production facility information includes at least an apparatus identifier (ID) of an apparatus, an operating state, and at least one of a setting value and a current value of a variable parameter related to cooperative production with a worker. The apparatus identifier of an apparatus is an identifier for identifying an apparatus, and is, for example, a number assigned to an apparatus or a name (apparatus name) of an apparatus. The collected production facility information may include information other than these pieces of information. For example, the production facility information to be collected may include at least one of a setting value and a current value of a variable parameter not related to cooperative production with a worker, presence or absence of occurrence of a failure, a warning, or the like, environmental data of a location where a production facility is installed, measurement data of a sensor installed inside or around a production facility, or the like. The measurement data is data obtained by measuring vibration, an electromagnetic wave, a current value, a voltage value, a power value, an amount of power, a temperature, or the like of a production facility.

The production facility information storage unit 104 stores production facility information. A new piece of the production facility information collected by the production facility information collection unit 103 is included in production facility information stored in the production facility information storage unit 104. The production facility information stored in the production facility information storage unit 104 may include production facility information other than production facility information collected by the production facility information collection unit 103. For example, the production facility information stored in the production facility information storage unit 104 may include, as production facility information other than production facility information collected by the production facility information collection unit 103, date and year of purchase, a model number, a manufacturing number, accumulated operating time, daily inspection record, maintenance record, upper or lower limit values indicating a settable range of a variable parameter related to cooperative production with a worker, upper and lower limit values indicating a settable range of a variable parameter not related to cooperative production with a worker, an operation plan, an operation record, or the like of a production facility.

The profile information evaluation unit 105 generates profile information based on worker information stored in the worker information storage unit 102 and production facility information stored in the production facility information storage unit 104. Then, the profile information evaluation unit 105 evaluates degree of change in profile information on the basis of comparison with reference profile information stored in the profile information storage unit 108.

When a new piece of worker information and a new piece of production facility information are collected, the profile information evaluation unit 105 sequentially generates profile information in real time from the worker information and the production facility information, and evaluates degree of change in the profile information based on comparison with reference profile information stored in the profile information storage unit 108.

In evaluating profile information, for example, a work speed of a worker or a production facility is calculated from a work start time and a work end time for each work object of the worker or the production facility. Further, a work failure occurrence rate of a worker or a production facility, a work failure occurrence rate for each piece of failure content, or the like is calculated from a result of inspection performed on a work object on which the worker or the production facility has performed the work in the past. Further, in a case where a picking apparatus of a component is included as a production facility, a picking success rate with respect to a component residual quantity is calculated from a total residual number (or total residual weight) of a picking target component group and success or failure of picking.

The profile information evaluation unit 105 evaluates at least one piece of profile information. Preferably, profile information corresponding to each of a plurality of workers or a plurality of production facilities is sequentially evaluated.

The evaluation result storage unit 106 stores an evaluation result of profile information corresponding to a worker and a production facility newly evaluated by the profile information evaluation unit 105.

An evaluation result of profile information stored in the evaluation result storage unit 106 includes at least work date and time data of a worker or a production facility, an identifier (ID) of a worker or a production facility, work content of a worker or a production facility, and profile information at the date and time. An evaluation result of profile information stored in the evaluation result storage unit 106 desirably includes an identifier (ID) of simultaneous workers or simultaneous production facilities in a case where there are workers (simultaneous workers) who work simultaneously or production facilities (simultaneous production facilities) that work simultaneously, or environment data of a location where a worker or a production facility is installed. Note that an evaluation result of profile information stored in the evaluation result storage unit 106 may include information other than these. For example, an evaluation result of profile information stored in the evaluation result storage unit 106 may include a change history of a production management system, work trouble information caused by poor physical condition of another worker or another worker leaving his or her seat or malfunction or failure of a production facility, or the like.

The simulation unit 107 performs simulation for estimating a correction method of correcting corresponding profile information and a correction effect when the correction method is performed on the basis of an evaluation result of the profile information stored in the evaluation result storage unit 106.

Note that, correction by the above correction method is performed so that overall work capacity of a worker and a production facility indicated by profile information becomes close to corresponding work capacity indicated by reference profile information.

Further, a correction effect estimated by the simulation unit 107 is indicated by, for example, a total cost (production cost) in a case where a production plan is executed based on profile information to which the above correction method is applied. Here, the production cost is, for example, obtained by converting work content added or time required as a correction method is applied, or the like into money that is a single evaluation index. However, an index indicating a correction effect is not limited to the above production cost, and may be, for example, a total energy amount required for manufacturing (production) or a total emission amount of carbon dioxide (CO₂) associated with manufacturing (production).

The profile information storage unit 108 stores reference profile information that is information indicating ideal or standard work capacity of a worker and ideal or standard work capacity of a production facility. That is, the reference profile information is information indicating overall work capacity of a worker and a production facility.

The reference profile information stored in the profile information storage unit 108 includes at least an identifier (ID) of a worker or a production facility, work content of a worker or a production facility, a reference profile information value, command content directly transmitted to a worker to achieve the reference profile information value, and control content directly transmitted to a production facility.

Desirably, reference profile information stored in the profile information storage unit 108 includes information for distinguishing whether a value indicated by the reference profile information is a standard value, a theoretical value in a case where a worker or a production facility is in an ideal state, a best value evaluated by the profile information evaluation unit 105, an average value evaluated by the profile information evaluation unit 105, a median value evaluated by the profile information evaluation unit 105, or a minimum value evaluated by the profile information evaluation unit 105, a latest update date and time of reference profile information, reference profile information of another worker (that is, a related worker who performs work related to work performed by a worker) or another production facility (that is, a related production facility that performs work related to work performed by a production facility) serving as a precondition, a precaution at the time of application of profile information, and the like.

The reference profile information of another worker or another production facility as a precondition means, for example, reference profile information set for another worker other than the worker himself or herself or another production facility, such as a conveyance speed of a line conveyance facility at a work speed of a picking robot. Further, the precaution at the time of application of profile information means a matter to be noted when profile information is applied for safety reasons or the like, such as necessity or unnecessity of an entry prevention fence due to a work speed of a picking robot.

Note that reference profile information stored in the profile information storage unit 108 may include information other than these. For example, reference profile information stored in the profile information storage unit 108 may include degree of fatigue of a worker at the time of application of profile information, an occurrence rate of poor physical condition of a worker, malfunction of a production facility, failure occurrence probability of a production facility, or the like.

The distribution content determination unit 109 determines a correction instruction (that is, command content or control content) for correction by a corresponding correction method of profile information applied to at least one of a worker and a production facility on the basis of a correction effect estimated by the simulation unit 107.

The configuration may be such that only one of command content for a worker and control content for a production facility is determined by the distribution content determination unit 109. For example, as command content for a worker, a change of a work procedure, a change of a work speed, an instruction to obtain a break, an instruction to engage in another piece of work (that is, a change of work content), or the like is assumed. Further, for example, as control content for a production facility, a setting change of a parameter, a setting change of a target value, a change of an operation mode, a correction of a production plan, a re-planning command, a warning issuing, or the like is assumed. Note that command content or control content determined by the distribution content determination unit 109 may include content other than the above examples.

The worker distribution unit 110 distributes, to a worker, information on command content applied to the worker among pieces of command content or control content determined by the distribution content determination unit 109. Further, the worker distribution unit 110 distributes, to a worker, information presented to the worker when control content for a production facility is applied to the production facility. The information to be presented is, for example, information that is desired to be presented for ensuring safety of a worker, improving work efficiency, or the like.

Information (that is, information on command content applied to a worker) distributed by the worker distribution unit 110 is displayed on a worker monitor used for work, a mobile terminal owned by a worker, or the like. Further, pieces of information distributed by the worker distribution unit 110 may be simultaneously displayed on a digital signage or the like in a factory. Further, information distributed by the worker distribution unit 110 may be distributed as voice information, various types of signal information, or the like.

It is desirable that the worker distribution unit 110 distribute information to be presented to a worker in real time when command content to be applied to the worker is determined so that the work assistance apparatus 11 can distribute information corresponding to command content or control content determined by the distribution content determination unit 109 in real time. Further, when command content to be applied to a worker is determined, the worker distribution unit 110 desirably distributes information corresponding to the command content to be applied to the worker to the worker in real time.

The production facility distribution unit 111 distributes information corresponding to control content applied to a production facility among pieces of command content or control content determined by the distribution content determination unit 109 to the production facility. The distributed information (that is, information on control content applied to a production facility) is a setting change command, a file describing a setting change command, a setting value, a change content of a setting value, or the like.

When information is distributed to a production facility by the production facility distribution unit 111, for example, a setting change command is directly transmitted to the production facility via a network or the like. The configuration may be such that a production facility is connected to a programmable logic controller, a database, or the like via a network or the like, a setting value is written in a programmable logic controller, a database, or the like, and a production facility updates its own setting value with reference to a written setting value. A file in which a setting change command is described may be output to a network folder or the like that can be accessed by both a production facility and the production facility distribution unit 111, and the production facility may read the file to update its own setting value.

The production facility distribution unit 111 desirably distributes information corresponding to control content applied to a production facility to the production facility in real time when the control content applied to the production facility is determined so that the work assistance apparatus 11 can distribute information corresponding to command content or control content determined by the distribution content determination unit 109 in real time.

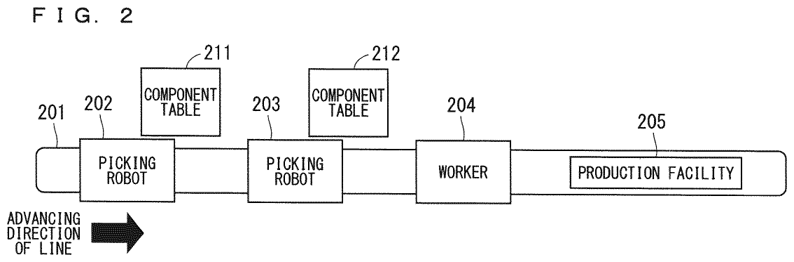

FIG. 2 is a diagram schematically illustrating an example of a configuration of a production line in which work is assisted by the work assistance system 1 according to the present embodiment.

As exemplified in FIG. 2, a picking robot 202, a picking robot 203, a worker 204, and a production facility 205 that controls work on a production line 201 are arranged on the production line 201.

The picking robot 202 takes out (picks) one of a plurality of components stacked in bulk on a component table 211 installed around the robot, and inserts the component into an assembly object (work object) conveyed on the production line 201. Similarly, the picking robot 203 takes out (picks) one of a plurality of components stacked in bulk on a component table 212 installed around the robot, and inserts the component into an assembly object (work object) conveyed on the production line 201.

The worker 204 performs work of fixing a new component to an assembly object (work object) into which the new component is inserted by these robots.

### <Regarding Operation of Work Assistance Apparatus>

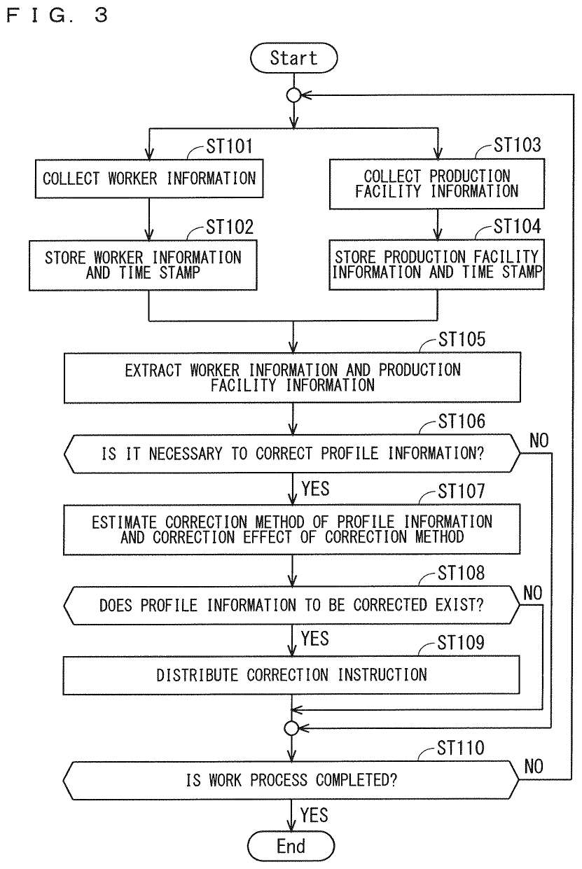

FIG. 3 is a flowchart illustrating an example of processing performed by the work assistance system 1 according to the present embodiment. Note that processes of Steps ST103 and ST104 in FIG. 3 are executed in parallel with Steps ST101 and ST102.

First, in Step ST101, the worker information collection unit 101 collects worker information from a sensor, a microphone, a camera, a touch panel, or the like attached to the body of the worker 204 or the vicinity of the worker 204. The collected worker information is, for example, measurement data measured by a sensor, a microphone, a camera, a touch panel, or the like.

Next, in Step ST102, the collected worker information and a time stamp associated with the worker information are stored in the worker information storage unit 102.

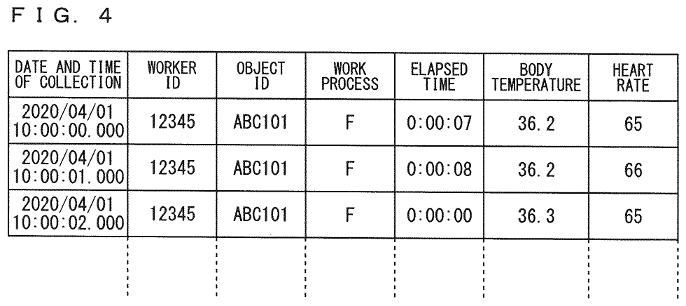

FIG. 4 is a diagram illustrating an example of worker information and a time stamp stored in the work assistance system 1 according to the present embodiment.

As illustrated in FIG. 4 as an example, the worker information includes a “worker ID” collected from the worker 204, an “object ID” for identifying a work object, a “work process”, “elapsed time” which is time required for a corresponding work process, a “body temperature”, and a “heart rate”.

On the other hand, in Step ST103 of FIG. 3, the production facility information collection unit 103 collects production facility information from the picking robot 202, the picking robot 203, and the production facility 205.

Next, in Step ST104, the collected production facility information and a time stamp associated with the production facility information are stored in the production facility information storage unit 104.

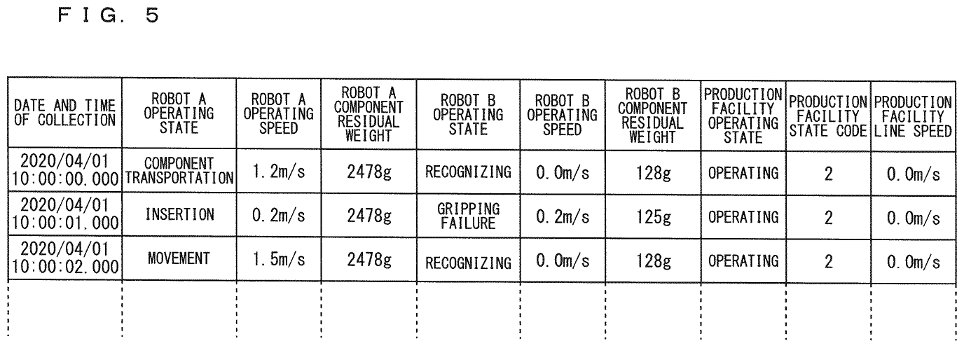

FIG. 5 is a diagram illustrating an example of production facility information and a time stamp stored in the work assistance system 1 according to the present embodiment.

As illustrated in FIG. 5 as an example, the production facility information includes an “operating state” of a robot, a “moving speed” of a robot, and a “component residual weight” collected from the picking robot 202 (robot A in FIG. 5). Further, the production facility information includes an “operating state” of a robot, a “moving speed” of a robot, and a “component residual weight” collected from the picking robot 203 (robot B in FIG. 5). Further, the production facility information includes an “operating state” of the production facility 205 collected from the production facility 205, a “state code” of the production facility 205, and a “line speed” of the production line 201 controlled by the production facility 205.

In Step ST105 in FIG. 3, the profile information evaluation unit 105 extracts the worker information stored in the worker information storage unit 102 in Step ST102, and extracts the production facility information stored in the production facility information storage unit 104 in Step ST104.

Further, the profile information evaluation unit 105 generates profile information based on the extracted worker information and production facility information, and evaluates the profile information based on reference profile information.

Here, the worker information and the production facility information are assumed to be worker information and production facility information associated with a time stamp of the latest same time. Alternatively, the worker information and the production facility information are assumed to be worker information and production facility information associated with a time stamp of a closest time within a set error range. The set error range in this case is, for example, a difference between a time interval at which worker information is collected and a time interval at which production facility information is collected or the like. According to such a pair of worker information and production facility information, profile information can be evaluated based on worker information and production facility information collected at substantially the same time. An evaluation result of profile information output from the profile information evaluation unit 105 is stored in the evaluation result storage unit 106 together with a time stamp.

Next, in Step ST106, the profile information evaluation unit 105 determines whether or not it is necessary to correct the evaluated profile information. In a case where it is determined that the evaluated profile information needs to be corrected, that is, in a case corresponding to “YES” branching from Step ST106 exemplified in FIG. 3, the processing proceeds to Step ST107 exemplified in FIG. 3. On the other hand, in a case where it is determined that the evaluated profile information does not need to be corrected, that is, in a case corresponding to “No” branching from Step ST106 exemplified in FIG. 3, the processing proceeds to Step ST110 exemplified in FIG. 3.

Determination as to whether or not it is necessary to correct the profile information is made on the basis of, for example, whether or not work capacity of either a current worker or production facility indicated by the profile information is lower than a predetermined reference value as compared with ideal or standard work capacity indicated by reference profile information stored in the profile information storage unit 108, whether or not an occurrence rate of an error or a failure in either a worker or a production facility is higher than a predetermined reference value, whether or not shortage of a scheduled production amount is predicted from utterance of a worker or an operation history of a touch panel, and the like.

In Step ST107, the simulation unit 107 performs simulation for estimating a correction method of the evaluated profile information and a correction effect when the correction method is performed.

For all evaluation results of profile information associated with each of a worker and a production facility, or for an evaluation result of profile information associated with each of a worker and a production facility, for which degree of change (degree of lowering) from work capacity indicated by reference profile information stored in the profile information storage unit 108 is evaluated to be larger than a predetermined reference value, the simulation unit 107 estimates a cause of lowering in work capacity indicated by corresponding profile information.

For example, in an operating state of a production facility as illustrated in FIG. 5, gripping failure occurs in the picking robot 203 (robot B in FIG. 5). Further, time during which the production facility 205 sets a line speed to 0 m/s (that is, time during which the production line 201 is stopped) is prolonged.

In such a case, the simulation unit 107 searches for a portion of profile information to be corrected in order to bring work capacity indicated by the evaluated profile information closer to work capacity of an ideal value or an average value indicated by reference profile information stored in the profile information storage unit 108 with reference to work capacity indicated by the reference profile information stored in the profile information storage unit 108.

For example, if a lower limit value of a component residual weight of the picking robot 203 is stored as a condition for achieving a gripping success rate (ideal value) of the picking robot 203 in reference profile information stored in the profile information storage unit 108, the simulation unit 107 calculates a correction method necessary for increasing a component residual weight of the picking robot 203 (that is, exceeding the above lower limit value) and production cost when the correction method is performed. In order to increase a component residual weight of the picking robot 203, for example, there are a method in which the worker 204 goes to a storage location to take a replenishment component and performs replenishment, and a method in which another worker (not illustrated in FIG. 2) is instructed to bring a replenishment component from a storage location.

When the worker 204 performs replenishment with a replenishment component, work that is originally supposed to be performed by the worker 204 is delayed by time required for the operation. For this reason, delay time of work of the worker 204 increases production cost as a result.

Similarly, when another worker (not illustrated in FIG. 2) is caused to perform replenishment with a replenishment component, work that is originally supposed to be performed by the another worker is delayed by time required for the operation. For this reason, delay time of work of another worker increases production cost as a result. However, on the other hand, since the worker 204 can perform work in the production line 201 during time until another worker brings a replenishment component, work of the worker 204 is promoted, and as a result, production cost is reduced. Increase or decrease in production cost in a case where another worker is caused to perform replenishment with a replenishment component is determined by the sum of these.

On the other hand, in a case where a method of not performing replenishment with a replenishment component of the picking robot 203 is selected, a difference between an estimated time of work completion in a case where work is continued without replenishment with a replenishment component of the picking robot 203 and a scheduled time of work completion determined at the time of planning of a production plan is calculated. Then, (delay) time corresponding to the difference increases production cost as a result.

In the above example, the method based on delay time of work is illustrated as a method of converting production cost. However, any method may be used as the method of converting production cost, such as a method of converting all other losses (delay and the like) including those other than work into production cost, a method of converting production cost on the basis of the number of failures or the number of errors, or a method of converting production cost on the basis of an extra investment amount necessary for correcting profile information.

As described above, a cause of lowering in work capacity indicated by profile information is estimated for all pieces of profile information to be corrected, and a correction method and production cost when the correction method is performed are calculated.

Next, in Step ST108, the distribution content determination unit 109 determines whether or not there is profile information to be corrected on the basis of a cause of lowering in work capacity estimated by the simulation unit 107 and production cost (correction effect) when the correction method is performed for all pieces of profile information to be corrected. Specifically, it is determined which profile information is to be corrected or which profile information is not to be corrected. Then, in a case where there is profile information to be corrected, that is, in a case corresponding to “YES” branching from Step ST108 exemplified in FIG. 3, the processing proceeds to Step ST109. On the other hand, in a case where there is no profile information to be corrected, that is, in a case corresponding to “NO” branching from Step ST108 exemplified in FIG. 3, Step ST109 is skipped, and the processing proceeds to Step ST110.

In a case where profile information is corrected, the distribution content determination unit 109 determines a correction method that minimizes production cost at the time of implementation. Further, the distribution content determination unit 109 causes the evaluation result storage unit 106 to store whether or not the above-described correction method is performed on profile information evaluated by the profile information evaluation unit 105 and the correction method. Desirably, a time stamp associated with the collected worker information, a time stamp associated with the collected production facility information, degree of lowering in estimated work capacity, whether or not the correction method is performed, and information indicating the correction method are associated with each other and stored in the evaluation result storage unit 106.

In Step ST109, at least one of the worker distribution unit 110 and the production facility distribution unit 111 distributes a correction instruction, which is an instruction for correcting corresponding profile information, to the worker 204, the picking robot 202, the picking robot 203, the production facility 205, and the like.

For example, in a case where there is a correction instruction (an instruction for correcting corresponding profile information) for the worker 204, the worker distribution unit 110 distributes, to the worker 204, a notification or the like for causing the worker 204 to execute the correction instruction. Further, in a case where there is a correction instruction for the picking robot 202, the picking robot 203, or the production facility 205, the production facility distribution unit 111 distributes a setting value or the like for applying the correction instruction to the picking robot 202, the picking robot 203, or the production facility 205.

Further, the worker distribution unit 110 distributes information presented to the worker 204 as a correction instruction is applied to the picking robot 202, the picking robot 203, or the production facility 205 to the worker 204 as necessary.

For example, in a case where profile information indicating lowering in work capacity that a gripping failure rate in the picking robot 203 increases is corrected, if a correction method in which the worker 204 goes to a storage location to take a replenishment component and performs replenishment in order to increase a component residual weight of the picking robot 203 is used, the worker distribution unit 110 distributes information for replenishment with a replenishment component of the picking robot 203 to the worker 204. Note that information is distributed via a speaker, a monitor or a worker, a portable information device terminal held by a worker, or the like.

Next, in Step ST110, the distribution content determination unit 109 determines whether or not a currently executed work process is completed. Then, in a case where the work process is completed, that is, in a case corresponding to “YES” branching from Step ST110 exemplified in FIG. 3, the operation ends. On the other hand, in a case where the work process is not completed, that is, in a case corresponding to “NO” branching from Step ST110 exemplified in FIG. 3, the processing returns to Steps ST101 and ST103 exemplified in FIG. 3 so that information for correcting profile information is collected.

According to the present embodiment, to which worker or production facility a correction instruction for correcting profile information is to be applied when work capability in the production line 201 is lowered can be automatically determined and applied on the basis of an evaluation result of profile information.

Therefore, even in a case where there is no individual determination by a worker or a line manager, it is possible to achieve a production plan at a reasonable cost while autonomously maintaining work capacity in the production line 201 to be necessary and sufficient for achieving a production plan created in advance.

### Second Embodiment

A work assistance apparatus, a work assistance system, and a work assistance method according to the present embodiment will be described. Note that, in description below, a constituent similar to a constituent described in the embodiment described above is denoted by the same reference numeral, and will be omitted from detailed description as appropriate.

### <Regarding Configuration of Work Assistance Apparatus>

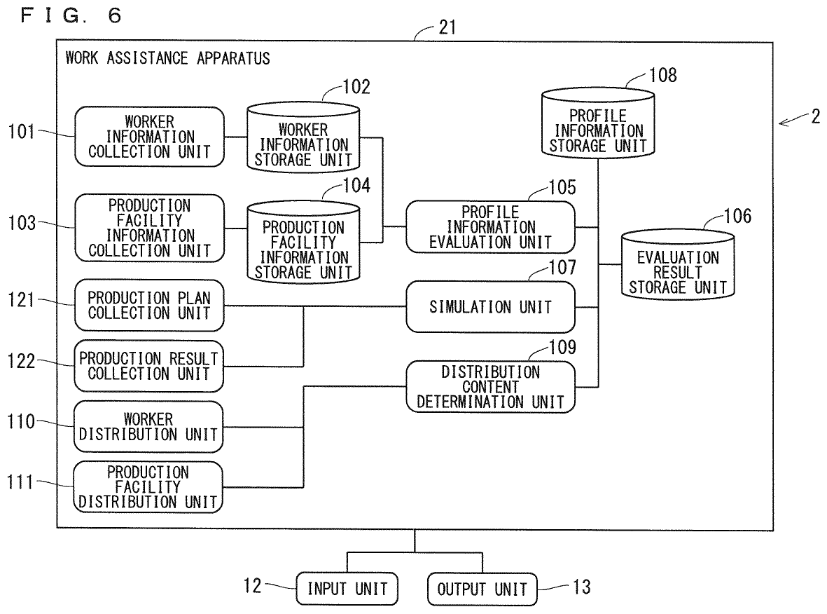

FIG. 6 is a diagram conceptually illustrating an example of a configuration of the work assistance system according to the present embodiment. As illustrated in FIG. 6 as an example, a work assistance system 2 includes a work assistance apparatus 21, the input unit 12, and the output unit 13.

The work assistance apparatus 21 includes the worker information collection unit 101, the worker information storage unit 102, the production facility information collection unit 103, the production facility information storage unit 104, the profile information evaluation unit 105, the evaluation result storage unit 106, the simulation unit 107, the profile information storage unit 108, the distribution content determination unit 109, the worker distribution unit 110, the production facility distribution unit 111, a production plan collection unit 121, and a production result collection unit 122. The production plan collection unit 121 and the production result collection unit 122 are connected to the simulation unit 107.

The production plan collection unit 121 collects a production plan. The production plan collected by the production plan collection unit 121 is a plan of work that is given to the production line 201 and that is performed by a worker and a production facility in cooperation. The production plan collected by the production plan collection unit 121 is, for example, a production plan for one day of a collected day. The production plan collected by the production plan collection unit 121 is, for example, a production plan created in a production planning system or the like existing outside the work assistance system 2. In a case where the collected production plan is a production plan created in an external production plan system, when the production plan collection unit 121 collects a production plan, the production plan collection unit 121 is connected to the production plan system via a network, and the production plan system can directly transmit the production plan to the production plan collection unit 121. Note that a file in which the production plan is described may be output to a network folder or the like accessible by both an external production plan system and the production plan collection unit 121, and the production plan collection unit 121 may read the file. Further, an external production plan system may output a production plan to a database, and the production plan collection unit 121 may read the output production plan.

The production result collection unit 122 collects a production result. The production result collected by the production result collection unit 122 is a production result achieved by the production line 201. The production result collected by the production result collection unit 122 is, for example, a production result collected in a production management system or the like existing outside the work assistance system 2. The production result collection unit 122 may directly collect a production result from the production facility 205. In a case where the collected production result is a production result collected in an external production management system, when the production result collection unit 122 collects a production result, the production result collection unit 122 is connected to the production management system via a network, and the production management system can directly transmit the production result to the production result collection unit 122. Note that a file in which a production result is described may be output to a network folder or the like accessible by both an external production management system and the production result collection unit 122, and the production result collection unit 122 may read the file. Further, an external production management system may output a production result to a database, and the production result collection unit 122 may read the output production result.

Simulation performed by the simulation unit 107 estimates a correction method of correcting profile information and a correction effect when the correction method is performed only in a case where a production plan is not achieved in view of influence on achievement of the production plan in a case where production is performed on the basis of profile information.

The distribution content determination unit 109 determines command content or control content corresponding to a correction instruction for profile information on the basis of a correction method estimated by the simulation unit 107 and a correction effect of the correction method.

### <Regarding Operation of Work Assistance Apparatus>

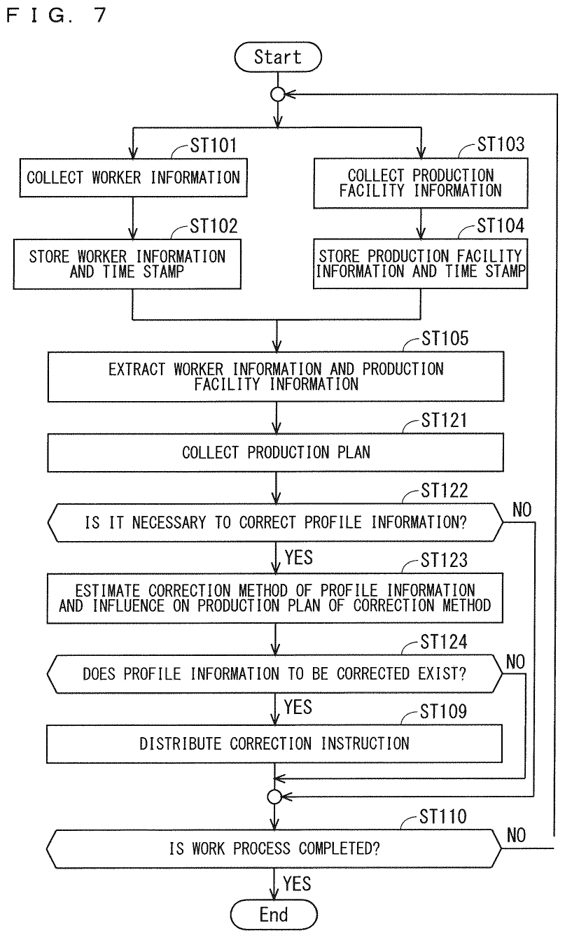

FIG. 7 is a flowchart illustrating an example of processing performed by the work assistance system 2 according to the present embodiment. Note that processes of Steps ST103 and ST104 in FIG. 7 are executed in parallel with Steps ST101 and ST102.

First, in Step ST101, the worker information collection unit 101 collects worker information from a sensor, a microphone, a camera, a touch panel, or the like attached to the body of the worker 204 or the vicinity of the worker 204.

Next, in Step ST102, the collected worker information and a time stamp associated with the worker information are stored in the worker information storage unit 102.

On the other hand, in Step ST103, the production facility information collection unit 103 collects production facility information from the picking robot 202, the picking robot 203, and the production facility 205.

Next, in Step ST104, the collected production facility information and a time stamp associated with the production facility information are stored in the production facility information storage unit 104.

Next, in Step ST105, the profile information evaluation unit 105 extracts the worker information stored in the worker information storage unit 102 in Step ST102, and extracts the production facility information stored in the production facility information storage unit 104 in Step ST104.

Further, the profile information evaluation unit 105 generates profile information based on the extracted worker information and production facility information, and evaluates the profile information based on reference profile information.

Next, in Step ST121, the production plan collection unit 121 collects a production plan. Then, the production result collection unit 122 collects a production result. The production plan and the production result collected by the production plan collection unit 121 and the production result collection unit 122 are a production plan and a production result at a current time. The simulation unit 107 can obtain the production plan and the production result collected by the production plan collection unit 121 and the production result collection unit 122.

Next, in Step ST122, the profile information evaluation unit 105 determines whether or not it is necessary to correct evaluated profile information in order to achieve a production plan. In a case where it is determined that the evaluated profile information needs to be corrected, that is, in a case corresponding to “YES” branching from Step ST122 exemplified in FIG. 7, the processing proceeds to Step ST123 exemplified in FIG. 7. On the other hand, in a case where it is determined that the evaluated profile information does not need to be corrected, that is, in a case corresponding to “No” branching from Step ST122 exemplified in FIG. 7, the processing proceeds to Step ST110 exemplified in FIG. 7.

The case where the profile information needs to be corrected as described above is a case where a production plan is predicted to be unable to be achieved with production efficiency estimated from a production result due to lowering in work capacity indicated by evaluated profile information.

In Step ST123, the simulation unit 107 performs simulation for estimating a correction method of correcting evaluated profile information and influence on achievement of a production plan when the correction method is performed.

Desirably, the simulation unit 107 estimates influence on achievement of a production plan when the above correction method is performed on the basis of a production result. For all evaluation results of profile information associated with each of a worker and a production facility, or for an evaluation result of profile information associated with each of a worker and a production facility, for which degree of lowering from work capacity indicated by reference profile information stored in the profile information storage unit 108 is evaluated to be larger than a predetermined reference value, the simulation unit 107 estimates a cause of lowering in work capacity indicated by profile information, and calculates a correction method and production cost (that is, a correction effect) when the correction method is performed.

Specifically, a correction effect for production efficiency when profile information is corrected by the above correction method is calculated. For a correction effect for production efficiency, production cost of zero is defined when, with a production result at the time of simulation as a start, an estimated work completion time is at a scheduled work completion time scheduled in a production plan by correction of profile information. Production cost is set such that, in a case where an estimated work completion time exceeds a scheduled work completion time, production cost calculated according to a length of excess time becomes large. Further, production cost is set such that, in a case where an estimated work completion time is less than a scheduled work completion time, production cost calculated according to a length of shortened time becomes large.

As described above, for all pieces of profile information to be corrected, a cause of lowering in work capacity indicated by the profile information is estimated, and production cost when a correction method is performed is calculated. Note that penalty in a case where a production plan cannot be complied with can be set as increase in corresponding production cost.

Next, in Step ST124, the distribution content determination unit 109 determines whether or not there is profile information to be corrected on the basis of a cause of lowering in work capacity estimated by the simulation unit 107 and production cost when the correction method is performed for all pieces of profile information to be corrected. Specifically, it is determined which profile information is to be corrected or which profile information is not to be corrected. Then, in a case where there is profile information to be corrected, that is, in a case corresponding to “YES” branching from Step ST124 exemplified in FIG. 7, the processing proceeds to Step ST109. On the other hand, in a case where there is no profile information to be corrected, that is, in a case corresponding to “NO” branching from Step ST124 exemplified in FIG. 7, Step ST109 is skipped, and the processing proceeds to Step ST110.

In a case where profile information is corrected, the distribution content determination unit 109 determines a correction method that minimizes production cost at the time of implementation. Further, the distribution content determination unit 109 causes the evaluation result storage unit 106 to store whether or not the above-described correction method is performed on profile information evaluated by the profile information evaluation unit 105 and the correction method. Desirably, a time stamp associated with the collected worker information, a time stamp associated with the collected production facility information, degree of lowering in estimated work capacity, whether or not the correction method is performed, and information indicating the correction method are associated with each other and stored in the evaluation result storage unit 106.

In Step ST109, at least one of the worker distribution unit 110 and the production facility distribution unit 111 distributes a correction instruction for correcting corresponding profile information to the worker 204, the picking robot 202, the picking robot 203, the production facility 205, and the like.

Next, in Step ST110, the distribution content determination unit 109 determines whether or not a currently executed work process is completed. Then, in a case where the work process is completed, that is, in a case corresponding to “YES” branching from Step ST110 exemplified in FIG. 7, the operation ends. On the other hand, in a case where the work process is not completed, that is, in a case corresponding to “NO” branching from Step ST110 exemplified in FIG. 7, the processing returns to Steps ST101 and ST103 exemplified in FIG. 7 so that information for correcting profile information is collected.

According to the present embodiment, to which worker or production facility a correction instruction for correcting profile information is to be applied when work capability in the production line 201 is lowered can be automatically determined and applied on the basis of an evaluation result of profile information including penalty cost in a case where a production plan cannot be complied with.

Therefore, even in a case where there is no individual determination by a worker, a line manager or the like, work capacity in the production line 201 can be autonomously corrected so that a correction method by which a production plan can be achieved is executed.

Further, if work capacity indicated by profile information is lowered, and a production plan is expected to be achieved based on the profile information, it is possible to prevent an unnecessary and non-urgent instruction which may impose a mental burden on a worker in particular by not correcting the profile information.

### Third Embodiment

A work assistance apparatus, a work assistance system, and a work assistance method according to the present embodiment will be described. Note that, in description below, a constituent similar to a constituent described in the embodiment described above is denoted by the same reference numeral, and will be omitted from detailed description as appropriate.

### <Regarding Configuration of Work Assistance Apparatus>

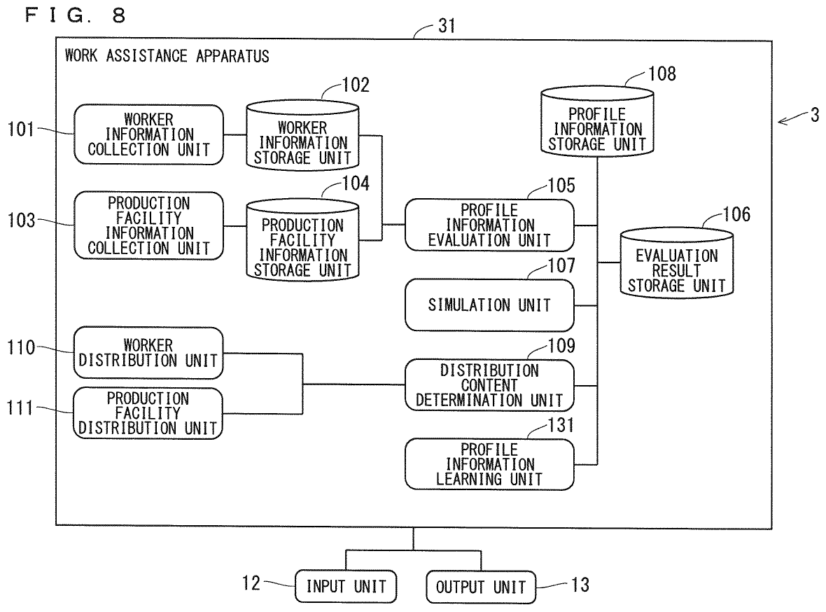

FIG. 8 is a diagram conceptually illustrating an example of a configuration of the work assistance system according to the present embodiment. As illustrated in FIG. 8 as an example, a work assistance system 3 includes a work assistance apparatus 31, the input unit 12, and the output unit 13.

The work assistance apparatus 31 includes the worker information collection unit 101, the worker information storage unit 102, the production facility information collection unit 103, the production facility information storage unit 104, the profile information evaluation unit 105, the evaluation result storage unit 106, the simulation unit 107, the profile information storage unit 108, the distribution content determination unit 109, the worker distribution unit 110, the production facility distribution unit 111, and a profile information learning unit 131.

The profile information learning unit 131 automatically performs machine learning on and updates ideal or standard reference profile information of a worker and a production facility to be stored in the profile information storage unit 108 on the basis of a plurality of pieces of worker information, a plurality of pieces of production facility information, a plurality of pieces of profile information based on these, history data of an evaluation result of profile information accumulated in the evaluation result storage unit 106, and the like.

The profile information learning unit 131 is desirably executed periodically by a task schedule function or the like. Further, the profile information learning unit 131 may be executed when new data is added to the evaluation result storage unit 106, or may be manually executed by the user of the work assistance system 3.

### <Regarding Operation of Work Assistance Apparatus>

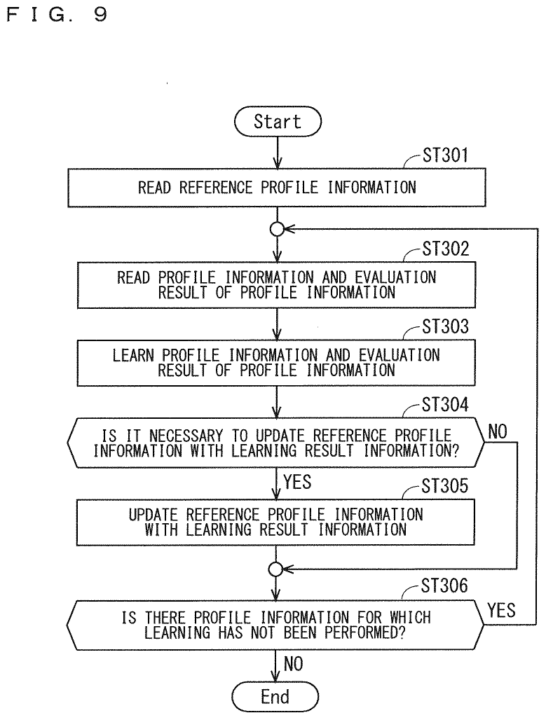

FIG. 9 is a flowchart illustrating an example of processing performed by the profile information learning unit 131 in the work assistance system 3.

First, in Step ST301, the profile information learning unit 131 reads reference profile information from the profile information storage unit 108.

Next, in Step ST302, the profile information learning unit 131 reads history data of profile information to be learned and history data of an evaluation result of the profile information from the evaluation result storage unit 106.

Next, in Step ST303, the profile information learning unit 131 performs machine learning on history data of profile information read in Step ST302 and history data of an evaluation result of the profile information. For example, in a case where profile information to be learned is expressed by an arithmetic mean, an arithmetic mean of history data is calculated. Further, in a case where profile information to be learned is expressed by a minimum value, a minimum value of history data is calculated. Further, in a case where profile information to be learned is expressed by an ideal value, a best value of history data is calculated.

Next, in Step ST304, the profile information learning unit 131 determines whether or not to update (that is, whether or not to replace) reference profile information with learning result information that is reference profile information obtained as a result of the above learning. In a case where it is determined that reference profile information needs to be updated with learning result information, that is, in a case corresponding to “YES” branching from Step ST304 exemplified in FIG. 9, the processing proceeds to Step ST305 exemplified in FIG. 9. On the other hand, in a case where it is determined that reference profile information does not need to be updated with learning result information, that is, in a case corresponding to “NO” branching from Step ST304 exemplified in FIG. 9, the processing proceeds to Step ST306 exemplified in FIG. 9.

For example, in a case where profile information to be learned is expressed by an arithmetic mean, it is determined to replace an arithmetic mean of history data if the arithmetic mean is different from an original value. Further, in a case where profile information to be learned is expressed by a minimum value, it is determined to replace a minimum value of history data if the minimum value is lower than an original value. Further, in a case where profile information to be learned is expressed by an ideal value, it is determined to replace a best value of history data if the best value is higher than an original value.

In Step ST305, the profile information learning unit 131 updates (replaces) reference profile information with learning result information.

In Step ST306, the profile information learning unit 131 determines whether or not there is profile information for which learning has not been performed. In a case where it is determined that there is profile information for which learning has not been performed, that is, in a case corresponding to “YES” branching from Step ST306 exemplified in FIG. 9, the processing returns to Step ST302 exemplified in FIG. 9. On the other hand, in a case where it is determined that there is no profile information for which learning has not been performed, that is, in a case corresponding to “NO” branching from Step ST306 exemplified in FIG. 9, the operation ends.

According to the present embodiment, reference profile information in the profile information storage unit 108 can be automatically updated using profile information and an evaluation result of the profile information. Therefore, it is possible to reflect aged deterioration of a production facility, an effect of improvement activity applied to a production line, a change in ability of a worker, or the like in reference profile information, so that an estimation effect of the simulation unit 107 can be improved.

### Fourth Embodiment

A work assistance apparatus, a work assistance system, and a work assistance method according to the present embodiment will be described. Note that, in description below, a constituent similar to a constituent described in the embodiment described above is denoted by the same reference numeral, and will be omitted from detailed description as appropriate.

### <Regarding Configuration of Work Assistance Apparatus>

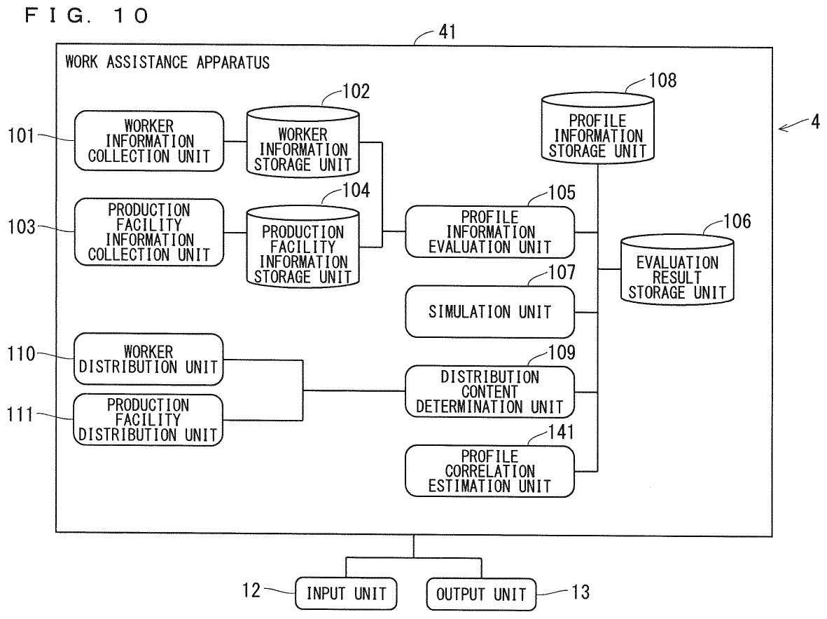

FIG. 10 is a diagram conceptually illustrating an example of a configuration of the work assistance system according to the present embodiment. As illustrated in FIG. 10 as an example, a work assistance system 4 includes a work assistance apparatus 41, the input unit 12, and the output unit 13.

The work assistance apparatus 41 includes the worker information collection unit 101, the worker information storage unit 102, the production facility information collection unit 103, the production facility information storage unit 104, the profile information evaluation unit 105, the evaluation result storage unit 106, the simulation unit 107, the profile information storage unit 108, the distribution content determination unit 109, the worker distribution unit 110, the production facility distribution unit 111, and a profile correlation estimation unit 141.

The profile correlation estimation unit 141 automatically estimates a correlation between pieces of profile information by machine learning or the like on the basis of a plurality of pieces of profile information, an evaluation result of the profile information, or a plurality of pieces of reference profile information. Then, the profile correlation estimation unit 141 adds information regarding a correlation between pieces of profile information to the profile information storage unit 108 or updates the information.

The profile correlation estimation unit 141 is desirably executed periodically by a task schedule function or the like. Further, the profile correlation estimation unit 141 may be executed when new data is added to the evaluation result storage unit 106, or may be manually executed by the user of the work assistance system 4.

### <Regarding Operation of Work Assistance Apparatus>

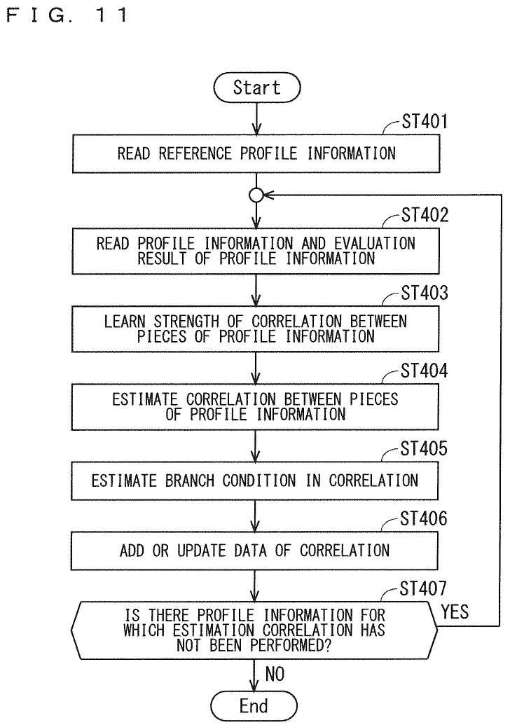

FIG. 11 is a flowchart illustrating an example of processing performed by the profile correlation estimation unit 141 in the work assistance system 4.

First, in Step ST401, the profile correlation estimation unit 141 reads a plurality of pieces of reference profile information from the profile information storage unit 108.

Next, in Step ST402, the profile correlation estimation unit 141 reads a plurality of pieces of profile information and an evaluation result of the profile information from the evaluation result storage unit 106.

Next, in Step ST403, the profile correlation estimation unit 141 performs machine learning on strength of a correlation between pieces of profile information.

Here, learning on strength of a correlation between pieces of profile information will be described using profile information of the production line 201 illustrated in FIG. 2 and an operating state of a production facility illustrated in FIG. 5 as an example.

A correlation coefficient between profile information “component residual weight” of the picking robot 202 and another piece of profile information is calculated. For example, a correlation coefficient with numerical data such as a “moving speed” of the picking robot 202 can be calculated by Formula (1) below.

$$\begin{matrix}[ Mathematical formula 1 ] & \\ Correlation coefficient r = \frac{Covariance between X and Y}{( Standard deviation of X ) \times ( Standard deviation of Y )} & Formula ( 1 )\end{matrix}$$

On the other hand, a correlation coefficient with category data such as an “operating state” of the picking robot 202 can be calculated by Formula (2) below.

$$\begin{matrix}[ Mathematical formula 2 ] & \\ Correlation coefficient r = \frac{Average between groups}{Overall average} = \frac{{Σ ( Group average - overall average )}^{2}}{{Σ ( Each value - overall average )}^{2}} & Formula ( 2 )\end{matrix}$$

A method of calculating a correlation coefficient between pieces of numerical data is not limited to Formula (1) above, and another calculation method such as an error rate from a regression line may be employed. Further, a method of calculating a correlation coefficient between numerical data and category data is not limited to Formula (2) above, and another calculation method such as a reciprocal of a distance between clusters in clustering may be employed. A method of calculating a correlation coefficient only needs to be determined such that a larger correlation coefficient between pieces of profile information indicates a stronger correlation. Further, a correlation coefficient between numerical data and category data is desirably calculated in units of category data in addition to all category data. As described above, a correlation coefficient can be calculated for all combinations of profile information.

Next, in Step ST404, the profile correlation estimation unit 141 estimates a correlation between pieces of profile information by using the correlation coefficient calculated in Step ST403.

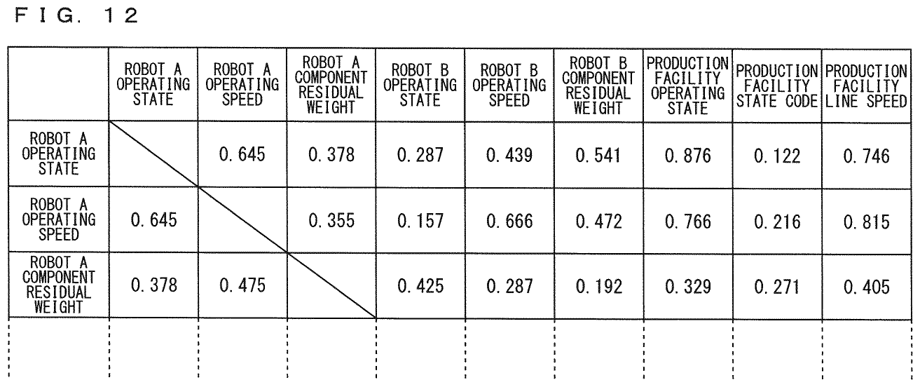

FIG. 12 is a diagram illustrating an example of a correlation coefficient for the picking robot 202. Referring to FIG. 12, a “production facility operating state”, a “production facility line speed”, and a “robot A moving speed” are extracted as profile information estimated to have a strong correlation with an “operating state” of the picking robot 202 (robot A in FIG. 12). As described above, a correlation between pieces of profile information is estimated.

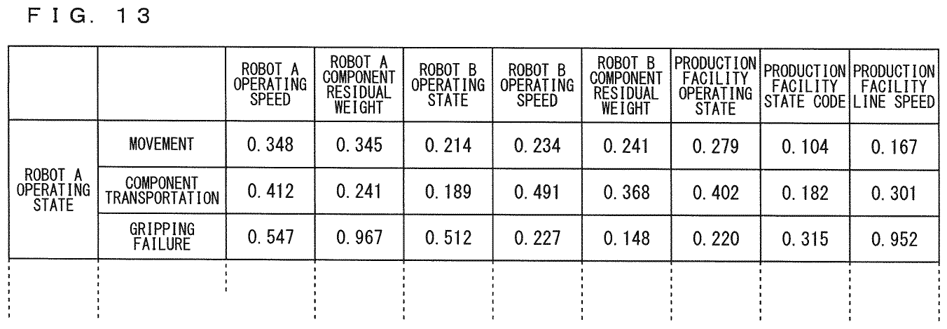

Further, FIG. 13 is a diagram illustrating an example of a correlation coefficient in units of category data for an “operating state” of the picking robot 202. As exemplified in FIG. 13, since an “operating state” of the picking robot 202 is expressed by category data, a correlation coefficient with another piece of profile information in units of category data can be calculated.

Referring to FIG. 13, it can be inferred that there is no profile information with a strong correlation for a category name “movement” or a category name “component transportation” with respect to an “operating state” of the picking robot 202, and there is a strong correlation with a “robot A component residual weight” and a “production facility line speed” for a category name “gripping failure”. Note that a predetermined threshold may be used as a criterion for determining presence or absence of a correlation, and an average value, a median value, or the like of correlation coefficients may be used as the threshold.

Next, in Step ST405, the profile correlation estimation unit 141 estimates a branch condition in a correlation between the pieces of profile information estimated in Step ST404.

For example, as a method of estimating a branch condition between numerical data and category data, such as a relationship between a category name “gripping failure” of an “operating state” of the picking robot 202 and a “robot A component residual weight” or a relationship between a category name “gripping failure” of an “operating state” of the picking robot 202 and a “production facility line speed”, a machine learning method such as random forest can be used.

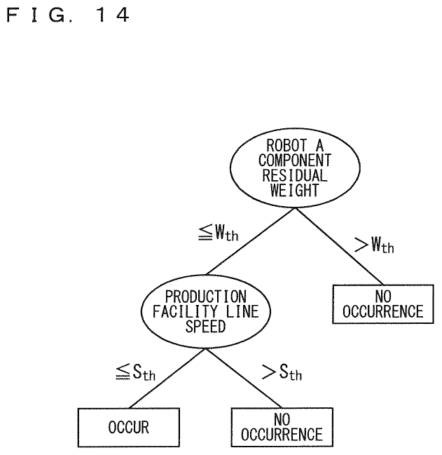

For example, it is assumed that, when an evaluation result of profile information accumulated in the evaluation result storage unit 106 is clustered with a “robot A component residual weight” and a “production facility line speed” as explanatory variables and an occurrence situation of a category name “gripping failure” of an “operating state” of the picking robot 202 as an objective variable, the result is as illustrated in FIG. 14. Here, FIG. 14 is a diagram illustrating an example of clustering of an evaluation result of profile information of a category name “gripping failure” in an “operating state” of the picking robot 202.

Referring to the result illustrated in FIG. 14, it can be said that a “gripping failure” is more likely to occur as a “robot A component residual weight” or a “production facility line speed” decreases. Further, it can be estimated that a component residual weight serving as a threshold at that time is Wth, and a line speed is Sth.

Further, based on this decision tree, since a branch condition of a “robot A component residual weight” is at a higher level than a branch condition of a “production facility line speed”, the “robot A component residual weight” is shown to be profile information to be preferentially changed. In a case where an objective variable is numerical data, another machine learning method such as k-means clustering may be applied in addition to random forest.

Next, in Step ST406, the profile correlation estimation unit 141 adds data of a correlation between the estimated profile information to the profile information storage unit 108 or updates the data.

Next, in Step ST407, the profile correlation estimation unit 141 determines whether or not there is profile information for which estimation of a correlation has not been performed. In a case where it is determined that there is profile information for which estimation of a correlation has not been performed, that is, in a case corresponding to “YES” branching from Step ST407 exemplified in FIG. 11, the processing returns to Step ST402 exemplified in FIG. 11. On the other hand, in a case where it is determined that there is no profile information for which estimation of a correlation has not been performed, that is, in a case corresponding to “NO” branching from Step ST407 exemplified in FIG. 11, the operation ends.

According to the present embodiment, a correlation between pieces of profile information and a branch condition of the profile information can be automatically estimated using the profile information and an evaluation result of the profile information. Therefore, it is possible to easily derive a condition or the like necessary for identifying a cause of lowering in work capacity indicated by profile information or correcting profile information for simulation performed by the simulation unit 107 by using the correlation described above. As a result, accuracy of simulation in the simulation unit 107 can be improved.

### <Regarding Hardware Configuration of Work Assistance System>

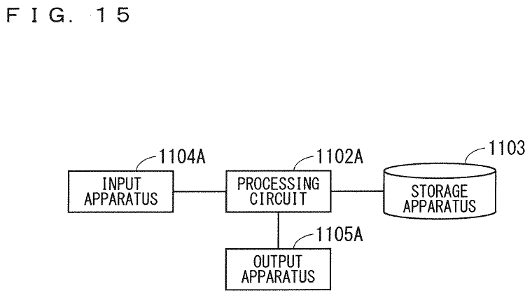

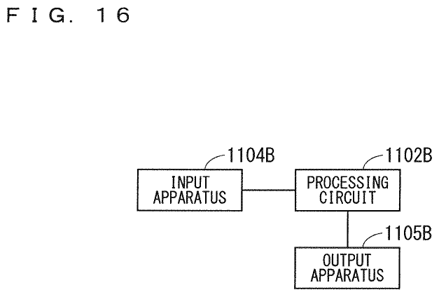

FIGS. 15 and 16 are diagrams schematically illustrating a hardware configuration in a case where the work assistance system exemplified in FIG. 1, FIG. 6, FIG. 8, or FIG. 10 is actually operated.

Note that there is a case where the hardware configuration illustrated in FIGS. 15 and 16 is consistent in number and the like with the configuration illustrated in FIG. 1, 6, 8, or 10, because the configuration illustrated in FIG. 1, 6, 8, or 10 indicate conceptual units.

Therefore, at least a case where one configuration illustrated in FIG. 1, 6, 8, or 10 includes a plurality of hardware configurations illustrated in FIGS. 15 and 16, a case where one configuration illustrated in FIG. 1, 6, 8, or 10 corresponds to a part of a hardware configuration illustrated in FIGS. 15 and 16, and a case where a plurality of configurations illustrated in FIG. 1, 6, 8, or 10 is included in one hardware configuration illustrated in FIGS. 15 and 16 may be assumed.

In FIG. 15, as a hardware configuration for realizing the input unit 12, the output unit 13, the worker information collection unit 101, the worker information storage unit 102, the production facility information collection unit 103, the production facility information storage unit 104, the profile information evaluation unit 105, the evaluation result storage unit 106, the simulation unit 107, the profile information storage unit 108, the distribution content determination unit 109, the worker distribution unit 110, the production facility distribution unit 111, the production plan collection unit 121, the production result collection unit 122, the profile information learning unit 131, the profile correlation estimation unit 141, or the like in FIG. 1, FIG. 6, FIG. 8, or FIG. 10, a processing circuit 1102A for performing calculation, a storage apparatus 1103 capable of storing information, an input device 1104A with which information can be input, such as a mouse, a keyboard, a touch panel, various switches, or the like, and an output device 1105A (including a case of functioning also as the input device 1104A) that can output information, such as a display, a liquid crystal display, a lamp, or the like are shown. This configuration is the same in any of the above embodiments.

In FIG. 16, as a hardware configuration for realizing the input unit 12, the output unit 13, the worker information collection unit 101, the worker information storage unit 102, the production facility information collection unit 103, the production facility information storage unit 104, the profile information evaluation unit 105, the evaluation result storage unit 106, the simulation unit 107, the profile information storage unit 108, the distribution content determination unit 109, the worker distribution unit 110, the production facility distribution unit 111, the production plan collection unit 121, the production result collection unit 122, the profile information learning unit 131, the profile correlation estimation unit 141, or the like in FIG. 1, FIG. 6, FIG. 8, or FIG. 10, a processing circuit 1102B for performing calculation, an input device 1104B with which information can be input, such as a mouse, a keyboard, a touch panel, various switches, or the like, and an output device 1105B (including a case of functioning also as the input device 1104B) that can output information, such as a display, a liquid crystal display, a lamp, or the like are shown. This configuration is the same in any of the above embodiments.

The worker information storage unit 102, the production facility information storage unit 104, the evaluation result storage unit 106, or the profile information storage unit 108 is realized by the storage apparatus 1103 or another storage apparatus (not illustrated here).

The storage apparatus 1103 may be, for example, a volatile or nonvolatile semiconductor memory such as a hard disk drive (that is, an HDD), a random access memory (that is, a RAM), a read-only memory (that is, a ROM), a flash memory, an erasable programmable read only memory (EPROM), an electrically erasable programmable read-only memory (EEPROM), or the like, a memory (recording medium) including a magnetic disk, a flexible disk, an optical disk, a compact disk, a mini disk, a DVD, or the like, or any recording medium to be used in the future.

The processing circuit 1102A may execute a program stored in the storage apparatus 1103, an external CD-ROM, an external DVD-ROM, an external flash memory, or the like. That is, for example, the processing circuit 1102A may be a central processing unit (that is, a CPU), a microprocessor, a microcomputer, or a digital signal processor (that is, a DSP).

In a case where the processing circuit 1102A executes a program stored in the storage apparatus 1103, an external CD-ROM, an external DVD-ROM, an external flash memory, or the like, the worker information collection unit 101, the production facility information collection unit 103, the profile information evaluation unit 105, the simulation unit 107, the distribution content determination unit 109, the worker distribution unit 110, the production facility distribution unit 111, the production plan collection unit 121, the production result collection unit 122, the profile information learning unit 131, or the profile correlation estimation unit 141 is realized by software, firmware, or a combination of software and firmware by which a program stored in the storage apparatus 1103 is executed by the processing circuit 1102A. Note that a function of the worker information collection unit 101, the production facility information collection unit 103, the profile information evaluation unit 105, the simulation unit 107, the distribution content determination unit 109, the worker distribution unit 110, the production facility distribution unit 111, the production plan collection unit 121, the production result collection unit 122, the profile information learning unit 131, or the profile correlation estimation unit 141 may be realized, for example, by cooperation of a plurality of processing circuits.

Software and firmware may be described as a program and stored in the storage apparatus 1103. In that case, the processing circuit 1102A realizes the above function by reading and executing a program stored in the storage apparatus 1103. That is, the storage apparatus 1103 may store a program that is executed by the processing circuit 1102A so that the above-described function is realized as a result.

Further, the processing circuit 1102B may be dedicated hardware. That is, for example, the processing circuit 1102B may be a single circuit, a composite circuit, a programmed processor, a parallel programmed processor, an integrated circuit (application specific integrated circuit, that is, an ASIC), a field-programmable gate array (FPGA), or a circuit combining them.

In a case where the processing circuit 1102B is dedicated hardware, the worker information collection unit 101, the production facility information collection unit 103, the profile information evaluation unit 105, the simulation unit 107, the distribution content determination unit 109, the worker distribution unit 110, the production facility distribution unit 111, the production plan collection unit 121, the production result collection unit 122, the profile information learning unit 131, or the profile correlation estimation unit 141 is realized by operation of the processing circuit 1102B. Note that a function of the worker information collection unit 101, the production facility information collection unit 103, the profile information evaluation unit 105, the simulation unit 107, the distribution content determination unit 109, the worker distribution unit 110, the production facility distribution unit 111, the production plan collection unit 121, the production result collection unit 122, the profile information learning unit 131, or the profile correlation estimation unit 141 may be realized by separate circuits, or may be realized by a single circuit.

Note that a function of the worker information collection unit 101, the production facility information collection unit 103, the profile information evaluation unit 105, the simulation unit 107, the distribution content determination unit 109, the worker distribution unit 110, the production facility distribution unit 111, the production plan collection unit 121, the production result collection unit 122, the profile information learning unit 131, or the profile correlation estimation unit 141 may be realized partially in the processing circuit 1102A that executes a program stored in the storage apparatus 1103, and partially in the processing circuit 1102B that is dedicated hardware.

Further, the input unit 12 is realized by the input device 1104A or the input device 1104B.

Further, the output unit 13 is realized by the output device 1105A or the output device 1105B (may also function as the input device).

### Regarding Effect Generated by Embodiment Described Above

Next, an example of an effect generated by the embodiment described above will be described. Note that, in description below, the effect will be described based on a specific configuration exemplified in the embodiment described above, but the configuration may be replaced with another specific configuration exemplified in the present description as long as a similar effect is generated. That is, hereinafter, for convenience, only one of associated specific configurations may be described as a representative, but the specific configuration described as a representative may be replaced with another specific configuration associated.

Further, the replacement may be performed across a plurality of embodiments. That is, the case may be such that a similar effect is generated by combination of configurations exemplified in different embodiments.

According to the embodiment described above, the work assistance apparatus includes the profile information evaluation unit 105, a correction estimation unit, and an instruction determination unit. Here, the correction estimation unit corresponds to, for example, the simulation unit 107 or the like. Further, the instruction determination unit corresponds to, for example, the distribution content determination unit 109. The profile information evaluation unit 105 generates at least one piece of profile information that is information including work capacity of a worker and work capacity of a production facility on the basis of at least one piece of worker information that is information on a worker who performs work in cooperation with a production facility and at least one piece of production facility information that is information on a production facility. Further, the profile information evaluation unit 105 evaluates degree of change in profile information with reference to reference profile information that is information including work capacity that is a reference of a worker and work capacity that is a reference of a production facility. The simulation unit 107 estimates a correction method of profile information and a correction effect caused by the correction method on the basis of evaluation by the profile information evaluation unit 105. On the basis of a correction effect, the distribution content determination unit 109 determines a correction instruction for at least one of a worker and a production facility for performing correction based on a corresponding correction method.

Further, according to the embodiment described above, the work assistance apparatus includes the input device 1104A, the output device 1105A, the processing circuit 1102A that executes the program, and the storage apparatus 1103 that stores a program to be executed. Then, the processing circuit 1102A executes a program, so that operation below is realized.

That is, at least one piece of profile information that is information including work capacity of a worker and work capacity of a production facility is generated on the basis of at least one piece of worker information that is information on a worker who performs work in cooperation with a production facility and at least one piece of production facility information that is information on a production facility. Then, profile information is evaluated with reference to reference profile information that is information including work capacity that is a reference of a worker and work capacity that is a reference of a production facility. Then, a correction method of profile information and a correction effect caused by the correction method are estimated on the basis of evaluation of profile information. Then, on the basis of a correction effect, a correction instruction for at least one of a worker and a production facility for performing correction based on a corresponding correction method is determined.

Further, according to the embodiment described above, the work assistance apparatus includes the input device 1104B, the output device 1105B, and the processing circuit 1102B that is dedicated hardware. Then, the processing circuit 1102B, which is dedicated hardware, performs operation below.

That is, the processing circuit 1102B, which is dedicated hardware, generates at least one piece of profile information that is information including work capacity of a worker and work capacity of a production facility on the basis of at least one piece of worker information that is information on a worker who performs work in cooperation with a production facility and at least one piece of production facility information that is information on a production facility. Then, profile information is evaluated with reference to reference profile information that is information including work capacity that is a reference of a worker and work capacity that is a reference of a production facility. Then, a correction method of profile information and a correction effect caused by the correction method are estimated on the basis of evaluation of profile information. Then, on the basis of a correction effect, a correction instruction for at least one of a worker and a production facility for performing correction based on a corresponding correction method is determined.

According to such a configuration, degree of change in work capacity in the production line 201 can be evaluated by comparison of profile information generated based on worker information and production facility information with reference profile information, a correction method of the profile information and a correction effect of the correction method can be estimated based on the evaluation, and a correction instruction for realizing the correction method can be determined. Therefore, work of at least one of a worker and a production facility in the production line 201 can be automatically corrected based on a change in work capacity in the production line 201 obtained from both worker information and production facility information, so that production efficiency in the production line can be improved.

Note that, even in a case where another configuration exemplified in the present description is appropriately added to the above configuration, that is, even in a case where another configuration in the present description not mentioned as the above configuration is appropriately added, a similar effect can be generated.

Further, according to the embodiment described above, a correction effect is indicated by production cost associated with correction based on a corresponding correction method. Then, the distribution content determination unit 109 determines content of a correction instruction for performing correction based on a correction method that minimizes production cost. According to such a configuration, it is possible to improve production efficiency in a production line while reducing increase in production cost due to correction of profile information. Further, by unifying evaluation indexes of a correction effects into one, various correction methods can be compared in a similar manner.

Further, according to the embodiment described above, the simulation unit 107 estimates a correction method such that at least one of work capacity of a worker and work capacity of a production facility indicated by profile information becomes closer to at least one of work capacity of a worker and work capacity of a production facility indicated by reference profile information. According to such a configuration, since profile information is corrected so that work capacity indicated by reference profile information is realized, production efficiency in a production line can be improved.

Further, according to the embodiment described above, reference profile information is information based on any one of a theoretical value, a best value, an average value, a median value, a highest value, and a lowest value in worker information and production facility information. According to such a configuration, profile information can be corrected so that ideal work capacity indicated by reference profile information is realized.

Further, according to the embodiment described above, reference profile information includes at least one of information on a related worker who performs work related to work performed by a worker, information on a related production facility that performs work related to work performed by a production facility, and a precaution in a case where work is performed based on profile information. According to such a configuration, since reference profile information includes information on a related worker and information on a related production facility, it is possible to correct profile information while also considering a state of another worker and a state of another production facility (that is, a substantially unchangeable conditions).

Further, according to the embodiment described above, the work assistance apparatus includes the production plan collection unit 121 and the production result collection unit 122. The production plan collection unit 121 collects a production plan which is a plan of work performed by a worker and a production facility in cooperation. The production result collection unit 122 collects a production result that is a result of work performed based on a production plan. Then, based on the evaluation by the profile information evaluation unit 105, a production plan, and a production result, the simulation unit 107 estimates a correction method and a correction effect only in a case where the production plan is not achieved based on profile information. According to such a configuration, since estimation of a correction method and a correction effect is limited to a case where a production plan is not achieved by work based on profile information, it is possible to restrict unnecessary and non-urgent correction that may impose a mental burden on a worker in particular.

Further, according to the embodiment described above, the work assistance apparatus includes the profile information learning unit 131. The profile information learning unit 131 performs machine learning based on at least a plurality of pieces of profile information and updates reference profile information. Then, the profile information evaluation unit 105 evaluates profile information with reference to reference profile information updated using machine learning. According to such a configuration, it is possible to improve accuracy of evaluation of profile information performed by the profile information evaluation unit 105 and accuracy of simulation for correcting profile information performed by the simulation unit 107 by performing machine learning for improving work capacity of a worker and the like on the basis of worker information, performing machine learning for aged deterioration of a production facility and the like on the basis of production facility information, and updating reference profile information using a learning result of these.

Further, according to the embodiment described above, the work assistance apparatus includes the profile correlation estimation unit 141. The profile correlation estimation unit 141 performs machine learning based on at least a plurality of pieces of profile information and estimates a correlation between pieces of profile information. Then, the simulation unit 107 estimates a correction method on the basis of a correlation between pieces of profile information. According to such a configuration, identification of a cause of lowering in work capacity indicated by profile information, estimation of a correction method of profile information, or the like in the simulation unit 107 can be performed efficiently. For this reason, accuracy of simulation performed by the simulation unit 107 can be improved.

According to the embodiment described above, the work assistance system includes the work assistance apparatus, the input unit 12 that inputs information to the work assistance apparatus, and the output unit 13 that outputs information from the work assistance apparatus. According to such a configuration, in the work assistance system, a correction instruction of profile information can be determined on the basis of worker information and production facility information. Therefore, work of at least one of a worker and a production facility in the production line 201 can be automatically corrected based on a change in work capacity in the production line 201 obtained from both worker information and production facility information, so that production efficiency in the production line can be improved.

According to the embodiment described above, in the work assistance method, at least one piece of profile information that is information including work capacity of a worker and work capacity of a production facility is generated on the basis of at least one piece of worker information that is information on a worker who performs work in cooperation with a production facility and at least one piece of production facility information that is information on a production facility. Then, profile information is evaluated with reference to reference profile information that is information including work capacity that is a reference of a worker and work capacity that is a reference of a production facility. Then, a correction method of profile information and a correction effect caused by the correction method are estimated on the basis of evaluation of profile information. Then, on the basis of a correction effect, a correction instruction for at least one of a worker and a production facility for performing correction based on a corresponding correction method is determined.

According to such a configuration, degree of change in work capacity in the production line 201 can be evaluated by comparison of profile information generated based on worker information and production facility information with reference profile information, a correction method of the profile information and a correction effect of the correction method can be estimated based on the evaluation, and a correction instruction for realizing the correction method can be determined. Therefore, work of at least one of a worker and a production facility in the production line 201 can be automatically corrected based on a change in work capacity in the production line 201 obtained from both worker information and production facility information, so that production efficiency in the production line can be improved.

Note that, in a case where there is no particular limitation, order in which each piece of processing is performed can be changed.

Further, even in a case where another configuration exemplified in the present description is appropriately added to the above configuration, that is, even in a case where another configuration in the present description not mentioned as the above configuration is appropriately added, a similar effect can be generated.

### Regarding Variation of Embodiment Described Above

In the embodiment described above, a dimension, a shape, a relative arrangement relationship, an implementation condition, and the like of each constituent may also be described, but these are one example in all aspects and are not restrictive.

Accordingly, numerous variations and equivalents, examples of which are not shown, are assumed within a scope of a technique disclosed in the description of the present application. For example, a case where at least one constituent is modified, added, or omitted, and a case where at least one constituent in at least one embodiment is extracted and combined with a component in another embodiment are included.

Further, as long as no contradiction arises, in a case where it is described in the above-described embodiment that “one” constituent is included, “one or more” of the constituents may be included.

Further, description in the description of the present application is referred to for all purposes related to the present technique, and none of the description is recognized as a conventional technique.

Further, each constituent described in the embodiment described above is assumed as software or firmware, or hardware corresponding to the software or firmware. As software, for example, the constituent is referred to as a “unit” or the like, and as hardware, for example, the constituent is referred to as a “processing circuit” (circuitry) or the like.

Further, a technique disclosed in the description of the present application may be in a case in which each constituent is provided in a plurality of apparatuses in a distributed manner, that is, in an aspect such as a system as a combination of a plurality of apparatuses.

### EXPLANATION OF REFERENCE SIGNS

1, 2, 3, 4: work assistance system
11, 21, 31, 41: work assistance apparatus
12: input unit
13: output unit
101: worker information collection unit
102: worker information storage unit
103: production facility information collection unit
104: production facility information storage unit
105, 3001: profile information evaluation unit
106: evaluation result storage unit
107: simulation unit
108: profile information storage unit
109: distribution content determination unit
110: worker distribution unit
111: production facility distribution unit
121: production plan collection unit
122: production result collection unit
131: profile information learning unit
141: profile correlation estimation unit
201: production line
202, 203: picking robot
204: worker
205: production facility
211, 212: component table
1102A, 1102B: processing circuit
1103: storage apparatus
1104A, 1104B: input device
1105A, 1105B: output device
3002: correction estimation unit
3003: instruction determination unit

1. A work assistance apparatus comprising:
at least one processor to execute a program; and
at least one memory to store the program which, when it is executed by the processor, performs processes of,
generating at least one piece of profile information that is information including work capacity of a worker who performs work in cooperation with a facility and work capacity of the facility based on at least one piece of worker information that is information on the worker and at least one piece of facility information that is information on the facility, and further evaluating degree of change in the profile information with reference to reference profile information that is information including work capacity that is a reference of the worker and work capacity that is a reference of the facility;
estimating a correction method of the profile information and a correction effect caused by the correction method based on evaluation obtained by evaluating degree of change; and
determining a correction instruction for at least one of the worker and the facility for performing correction based on a corresponding one of the correction method based on the correction effect.

2. The work assistance apparatus according to claim 1, wherein:
the correction effect is indicated by production cost associated with correction based on a corresponding one of the correction method, and
in the process of determining the correction instruction, content of the correction instruction for performing correction based on the correction method that minimizes the production cost.

3. The work assistance apparatus according to claim 1, wherein:
in the process of estimating the correction method, the correction method is estimated such that at least one of the work capacity of the facility and the work capacity of the worker indicated by the profile information becomes closer to at least one of the work capacity of the facility and the work capacity of the worker indicated by the reference profile information.

4. The work assistance apparatus according to claim 1, wherein:
the reference profile information is information based on any one of a theoretical value, a best value, an average value, a median value, a highest value, and a lowest value in the worker information and the facility information.

5. The work assistance apparatus according to claim 1, wherein:
the reference profile information includes at least one of information on a related worker who performs work related to work performed by the worker, information on a related facility that performs work related to work performed by the facility, and a precaution in a case where work is performed based on the profile information.

6. The work assistance apparatus according to claim 1, wherein:
the processes further include:
collecting a production plan that is a plan of work performed by the worker and the facility in cooperation; and
collecting a production result that is a result of work performed based on the production plan, and
in the process of estimating the correction method and the correction effect, the correction method and the correction effect are estimated only in a case where the production plan is not achieved based on the profile information, based on the evaluation, unit the production plan, and the production result.

7. The work assistance apparatus according to claim 1, wherein:
the processes further include performing machine learning based on at least a plurality of pieces of the profile information and updating the reference profile information, and
the profile information is evaluated with reference to the reference profile information updated using machine learning.

8. The work assistance apparatus according to claim 1, wherein:
the processes further include performing machine learning based on at least a plurality of pieces of the profile information and estimating a correlation between pieces of the profile information, and
in the process of estimating the correction method, the correction method is estimated based on a correlation between pieces of the profile information.

9. A work assistance system comprising:
the work assistance apparatus according to claim 1;
an input device that inputs information to the work assistance apparatus; and
an output device that outputs information from the work assistance apparatus.

10. A work assistance method comprising:
generating at least one piece of profile information that is information including work capacity of a worker who performs work in cooperation with a facility and work capacity of the facility based on at least one piece of worker information that is information on the worker and at least one piece of facility information that is information on the facility;
evaluating the profile information with reference to reference profile information that is information including work capacity that is a reference of the worker and work capacity that is a reference of the facility;
estimating a correction method of the profile information and a correction effect caused by the correction method based on evaluation with respect to the profile information; and
determining a correction instruction for at least one of the worker and the facility for performing correction based on a corresponding one of the correction method based on the correction effect.

11. The work assistance method according to claim 10, wherein:
the correction effect is indicated by change in production cost associated with correction based on a corresponding one of the correction method, and
determining the correction instruction includes determining content of the correction instruction for performing correction based on the correction method that minimizes the production cost after change.

12. The work assistance method according to claim 11, wherein:
estimating the correction method includes estimating the correction method such that at least one of the work capacity of the facility and the work capacity of the worker indicated by the profile information becomes closer to at least one of the work capacity of the facility and the work capacity of the worker indicated by the reference profile information.

13. The work assistance method according to claim 11, further comprising:
collecting a production plan that is a plan of work performed by the worker and the facility in cooperation, and a production result that is a result of work performed based on the production plan,
wherein estimating the correction method and the correction effect includes estimating the correction method and the correction effect only in a case where the production plan is not achieved based on the profile information, based on evaluation with respect to the profile information, the production plan, and the production result.
